(19) United States
(12) Patent Application Publication
(10) Pub. No.: US 2025/0373721 A1
(43) Pub. Date: Dec. 4, 2025

(54) Wearable device and method for AI applications

(71) Applicant: Tianxin Wang, Walnut Creek, CA (US)

(72) Inventors: Leonardo Wang, Walnut Creek, CA (US); Tianxin Wang, Walnut Creek, CA (US)

(21) Appl. No.: 19/218,358

(22) Filed: May 25, 2025

Related U.S. Application Data
(60) Provisional application No. 63/655,072, filed on Jun. 2, 2024.
(60) Provisional application No. 63/739,080, filed on Dec. 26, 2024.

(51) Int. Cl. H04M 1/72412; H04M 1/72409

(52) U.S. Cl. CPC H04M 1/72412; H04M 1/724095; H04M 1/724097; H04M 2250/20

(57) ABSTRACT

An artificial intelligence enabled system and method of use is disclosed. The system comprises a host computer such as a cellphone, and a wearable device suitable for AI applications. The device is a wearable watch type device or a head worn device that can communicate with the host computer.

### CROSS-REFERENCE TO RELATED APPLICATIONS

This application claims benefit of and priority to U.S. Provisional Patent Application Ser. No. 63/655,072 filed on Jun. 2, 2024, and 63/739,080 filed on Dec. 26, 2024; which are incorporated herein by reference in its entirety for all purposes. The entire disclosure of the prior application is considered to be part of the disclosure of the instant application and are hereby incorporated by reference.

### BACKGROUND

Artificial intelligence (AI) has had tremendous advancements in recent years. An AI device is a hardware device that an AI powered computer uses to transfer information and perform user requested operations. Smart glasses such as google glasses and Meta AI glasses are exemplary eye wearable AI devices. Other AI peripheral devices include Humane Ai Pin, a wearable voice-operated virtual assistant device; and Rabbit r1, an Android-powered, ChatGPT-based personal assistant device. However existing AI devices do not comprehend human-oriented interfaces efficiently in fulfilling user requests in a humane way. Their weight and performance are often not satisfactory for convenient daily use.

### SUMMARY OF THE INVENTIONS

An artificial intelligence enabled system and method of use is disclosed. The system comprises a host computer such as a cellphone, and a wearable device suitable for AI applications. The device is a wearable watch type device or a head worn device that can communicate with the host computer.

The system includes a core component (e.g. an AI powered cellphone) for enabling AI-powered interactions between the system and its users and one or more wearable devices that collect user's input, communicate with the core component, receive feedback from the core component and interact with the user accordingly.

In an embodiment, the method comprises: receiving context data per user instruction from a wearable multimedia device, the wearable multimedia device including at least one wearable data capture device for capturing the context data; transferring the context data processing to a cell phone having with one or more AI powered applications; processing the context data through application; and sending output of the data processed to the wearable multimedia device for presentation of the output.

In an embodiment, a body-worn (wearable) device comprises: a camera and a microphone; one or more processors; memory storing instructions that when executed by the one or more processors, cause the one or more processors to perform operations comprising: capturing, using the camera and/or microphone, a set of digital image and/or sound data; transferring the data to a cell phone for processing; obtaining the output of processed data from the cellphone; and display or speak out the content of the output.

### BRIEF DESCRIPTION OF THE DRAWINGS

FIG. 1 shows examples of wrist wearable devices having foldable displays and one or more cameras embedded.

FIG. 2 shows an example of a wrist wearable device with rotatable display.

FIG. 3 shows an example of a wrist wearable device with displays that can slide.

FIG. 4 shows an example of another type of foldable display.

FIG. 5 shows examples of a device with rotatable foldable displays and camera.

FIG. 6 shows an example of the folding/unfolding mechanism of a device having 3 displays.

FIG. 7 shows another example of the folding/unfolding mechanism of the device having 3 displays.

FIG. 8 shows another example of the folding/unfolding mechanism of the device having 3 displays.

FIG. 9A shows other examples of the device having multiple displays that are foldable or rollable.

FIG. 9B shows an example of a device having extra displays that can be pulled out from the main body.

FIG. 9C shows an example of a device having extra displays that are foldable.

FIG. 10 shows examples of devices that have multiple screen displays.

FIG. 11 shows the top view of a smartwatch having a foldable display with 3 display screens and two cameras on its wristband.

FIG. 12 shows a side view of the device in FIG. 11.

FIG. 13 shows examples of devices that allow the display to be tilted.

FIG. 14 shows an example of a device using a wrist band having snap fasteners.

FIG. 15 shows an example of a device having one camera on the wristband and another camera on the rotatable watch main body.

FIG. 16 shows an example of a device having a camera that can slide on the wristband to provide a different view.

FIG. 17A shows an example of a device having retractable wire within the wristband.

FIG. 17B shows an example of a device having retractable wire on top of the wristband.

FIG. 17C shows an example of a device having retractable coil type wire in the open part of the wristband.

FIG. 17D shows an example of a device having a wire that runs across the main body and is on the surface of the other end of the wristband.

FIG. 17E shows an example of a device having electrically conductive rail on the wristband.

FIG. 17F shows an example of a device having an electrically conductive rail inside the cavity of the wristband which has a slit on its surface.

FIG. 17G shows the transparent view of an example of a device having wire that folds/bends within the wristband when the camera moves.

FIG. 17H shows the side view of the device of FIG. 17G.

FIG. 17I shows the X-ray view of an example of a device having wire inside the wristband to power the camera wirelessly.

FIG. 17J shows an example of the wrist band part having a camera on it is longer than the wrist band part without camera.

FIG. 17K shows examples of devices having more than one camera facing different directions integrated within a camera housing.

FIG. 17L shows an example of a device having a camera that can rotate to see different directions.

FIG. 18 shows an example of a device having a rotatable camera housing on a base structure that can be pulled out from the watch main body.

FIG. 19 shows an example of a device having a rotatable camera housing on a base structure that can slide relative to the watch main body.

FIG. 20 shows an example of a device having a rotatable camera housing that can rotate vertically.

FIG. 21 shows an example of a device having a rotatable camera housing that has two parts and one part can rotate relative to another part.

FIG. 22 shows an example of a device having a rotatable camera housing that can rotate in the same planar of the main body.

FIG. 23 shows an example of a device having a camera housing body can be folded to provide different view angles

FIG. 24 shows an example of a device having a camera housing body that is semi rigid.

FIG. 25 shows an example of a device having a semi rigid camera housing body that can be further rotated.

FIG. 26 shows an example of a device having a semi rigid camera housing body with multiple cameras.

FIG. 27 shows an example of a device having a camera housing body that is immobilized on the wrist band.

FIG. 28 shows examples of an earpiece having a camera.

FIG. 29 shows additional examples of an earpiece having one or more cameras.

FIG. 30 shows examples of head wearable devices having a headband.

FIG. 31 shows additional examples of head wearable devices having a headband.

FIG. 32 shows additional examples of head wearable devices having a non-vertical headband.

FIG. 33 shows an additional example of a head wearable device having horizontal headband.

FIG. 34 shows additional examples of head wearable devices.

FIG. 35 shows an example of a head wearable device with a movable display.

FIG. 36 shows examples of head wearable devices with foldable displays.

FIG. 37 shows examples of head wearable devices having neckpieces on the user's head.

FIG. 38 shows examples of head wearable devices having neckpieces not worn by the user.

FIG. 39 shows examples of hat shaped head wearable devices.

FIG. 40 shows examples of wearable batteries in the hat or headband.

FIG. 41 shows examples of other forms of wearable battery.

### DETAILED DESCRIPTION

Current inventions disclose wearable devices suitable for AI applications and methods of using them. In embodiments, the device is a wearable watch type device that has a configuration/shape/structure to be worn on the wrist. In other embodiments, the device is a head worn device that has a configuration/shape/structure to be worn on the head.

In some embodiments, the device is a wearable smart watch type device, which comprises one or more displays, one or more cameras, one or more speakers and microphones, means (hardware and software) to communicate with a host device such as a mobile device (e.g. a smart cell phone) or computer or a cloud computing source; and can transmit data including command, image/video/sound between said wearable device and the host device. In some preferred embodiments, the display is a foldable display. In some preferred embodiments, the camera is placed on the watchband/wristband of the watch type device. In some preferred embodiments, the display screen or the smart watch main body is rotatable and/or can be tilted. The device can have one or more control buttons or touch/tap control on it to control its activity such as on/off control and function control.

In some embodiments, the device is an earpiece that can be placed (e.g. hung) on top of the ear and host one or more cameras with an optional head band. In some embodiments, the device has a camera housing body that is connected to a headband and is hung at the side of the face such as the temple area or the area above the ear. The device can have one or more control buttons or touch/tap control on it to control its activity such as on/off control and function control. The device comprises one or more cameras, one or more speakers and microphones, optional display, means to communicate with a host device such as a mobile device (e.g. a smart cell phone) or computer or a cloud computing source; and can transmit data including command, image/video/sound between said wearable device and the host device. The device can have one or more control buttons or touch/tap control on it to control it such as on/off control and function control.

The wrist wearable or head wearable device can send commands/data to the host device (the core component) using wireless signal (wirelessly), the host processes the data and sends back data/commands to the wearable device wirelessly, the wearable device can follow the command from the host device and present the data from the host to the user in the wearable device. The wearable device comprises all necessary means (hardware such as chips, electric circuitry and software) built within to perform its activity. A user can also have both wrist wearable device and head wearable device work together forming a network with the host device.

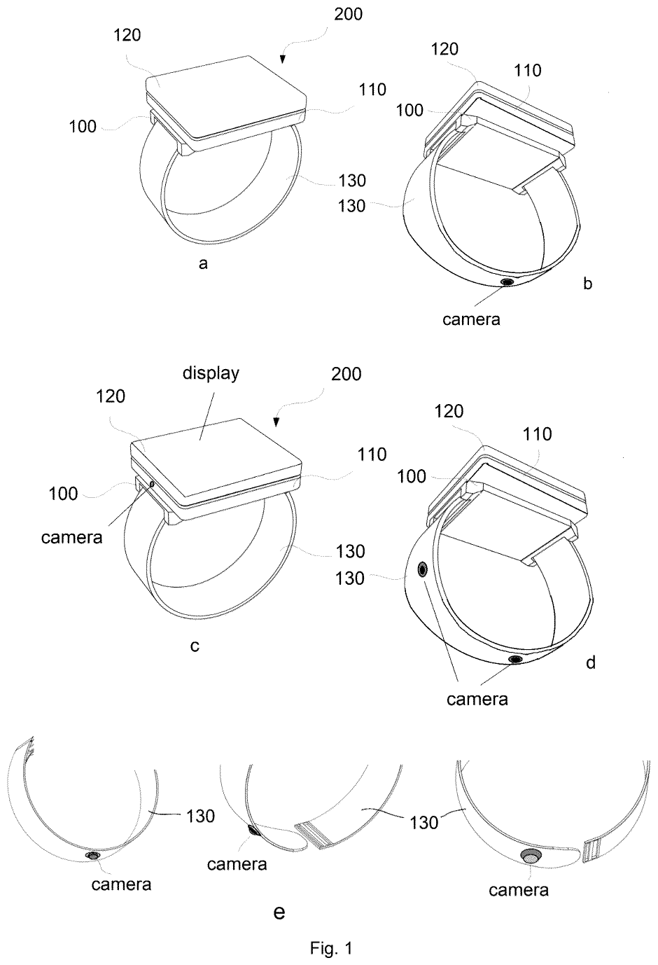

In some embodiments as shown in FIG. 1-3, the wrist wearable device comprises wristband 130, base (e.g. a support plate) 100, main body 200 which comprises a first body 110 and a second body 120 that can be folded and unfolded. The main body 200 can have a hinge structure to allow it to be folded and unfolded.

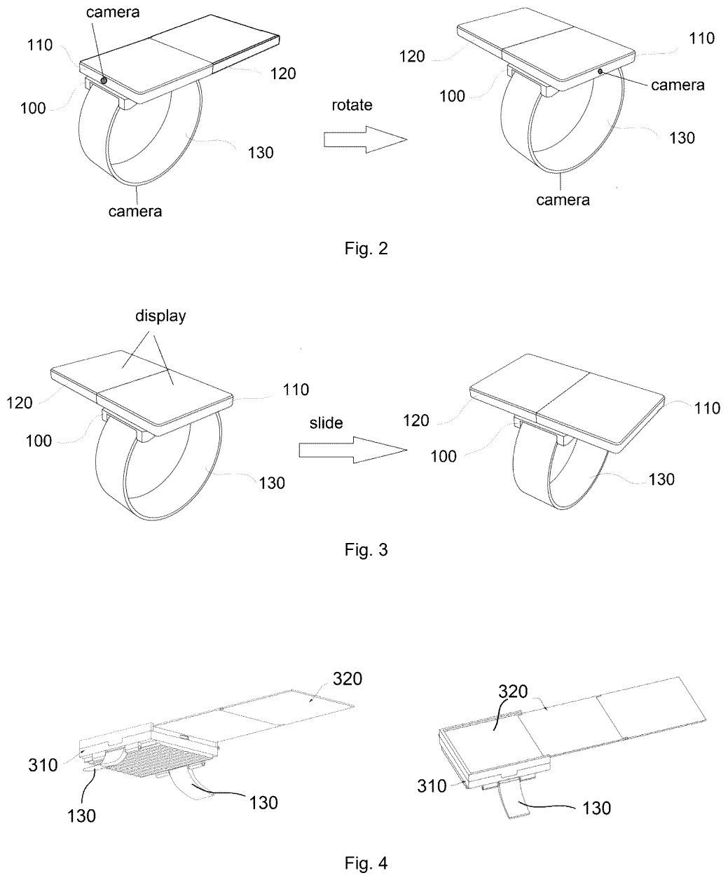

As shown in FIGS. 1a-1c, first body 110 and second body 120 have display screens that can be folded and unfold, which are on top of base 100 such as a supporting plate, similar to those disclosed in China patent No. CN213457673U. The display screens can be on both sides of 120 as shown in FIG. 1c and FIG. 3. In addition, one or more cameras are placed on the wristband 130 as shown in FIGS. 1b, 1d and 1e, which allow the user to take picture or video for the view perpendicular to the wrist or for the view below the wrist. One or more cameras can also be placed on the main body such as the side of second body 110 as shown in FIG. 1c and FIG. 2. FIG. 1e shows exemplary wristband configurations having the camera embedded.

The display can be a touch screen. The touch screen can also be used to control the camera. Optional buttons or tap control means can be placed close to the camera to turn it on or off.

In some embodiments, the display screens can be further rotated. As shown in FIG. 2, main body 200 is unfolded. The first body 110 and second body 120 are rotated 90 degrees from perpendicular to the wrist configuration to the same direction to the wrist to allow the user to see the displays from different angles and provide convenience to wear the unfolded form. Varieties of mechanisms can be adopted to allow the display to be rotatable. For example, base 100 can have a rotatable disk/shaft/rotor attached to the main body 200/body 110, or the main body 200/body 110 is attached to the base 100 with a magnet therefore it can be rotated freely. In some embodiments, the device has no base 100, the main body 200 is directly attached to the wristband and is rotatable. Additional examples of rotatable mechanisms can be found in China patent No. CN105378581.

Example in FIG. 2 shows the display rotated 90 degrees. It can also rotate further such as 180 degrees or 270 degrees. The orientation of content on the display can either rotate accordingly or does not rotate with the display, therefore the content will keep the same relative orientation to the wrist. Control means such a button or touching the screen or voice command can be used to control the orientation of the content on the display.

In some embodiments, the display can slide relative to the supporting plate or wrist band. For example, as shown in FIG. 3, a sliding groove is provided on the supporting plate 100, a sliding block is provided on the first body corresponding to the sliding groove, and the first body can slide in a range defined by the sliding groove relative to the supporting plate, similar to those described in China Patent No. CN213457673. Additional sliding mechanisms/configurations can be found in China patent No. CN213457673 as well. In some embodiments, the display can slide and rotate relative to the supporting plate or wrist band.

FIG. 4 shows another type of foldable display. The device comprises a main body mechanism 310, wherein a screen mechanism is fixedly arranged on one side of the inner wall of the main body mechanism. The screen mechanism comprises three display screens 320. Similar mechanism/configuration and more details can be found in China patent application No. CN116184804A.

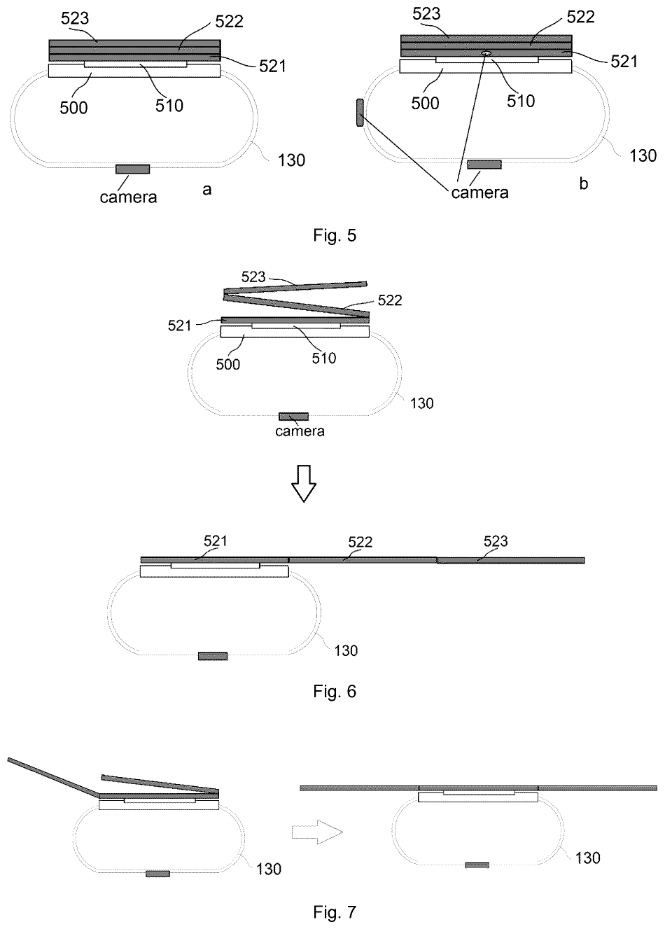

FIG. 5 shows examples of another type of device with a foldable display. The device has 3 foldable displays 521, 522 and 523. They are attached to the base 500 through a rotatable disk/shaft/rotor 510. Device in FIG. 5a has one camera to allow the user to take pictures/video for the view below the wrist. Device in FIG. 5b has three cameras to allow the user to take pictures/video for the view below the wrist, the side view perpendicular to the wrist and the view along the wrist direction. Similar mechanism/configuration and more details can be found in China patent No. CN220208108U.

FIG. 6 shows an example of the folding/unfolding mechanism of the device having 3 displays as shown in FIG. 5.

FIG. 7 shows another example of the folding/unfolding mechanism of the device having 3 displays similar to those shown in FIG. 5. The folding hinge position is different from those in FIG. 6.

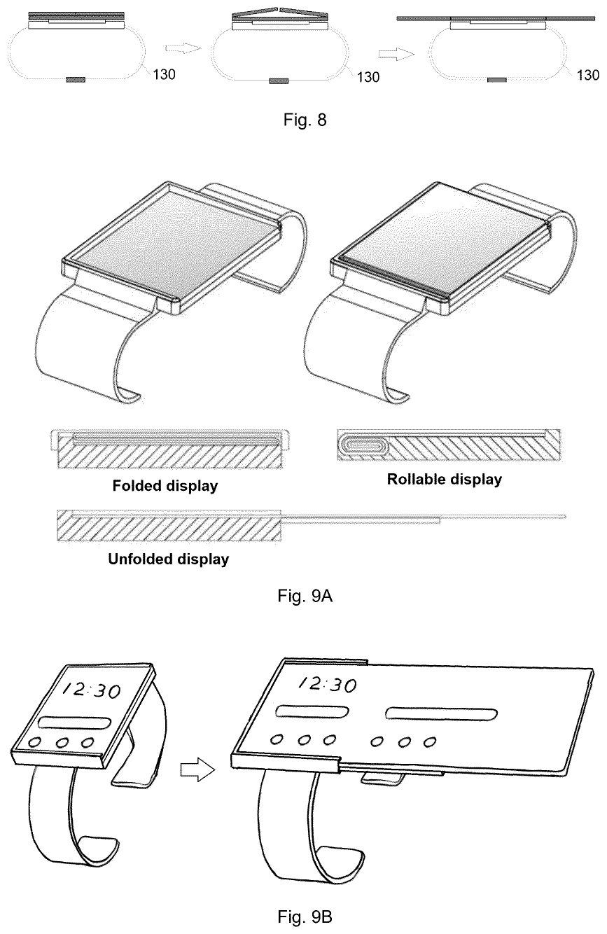

FIG. 8 shows another example of the folding/unfolding mechanism of the device having 3 displays similar to that shown in FIG. 5. Two displays on top are smaller than the one underneath. Additional folding display mechanisms that can be used for the current invention can be readily adopted from the disclosure in China patent application No. CN117715345A.

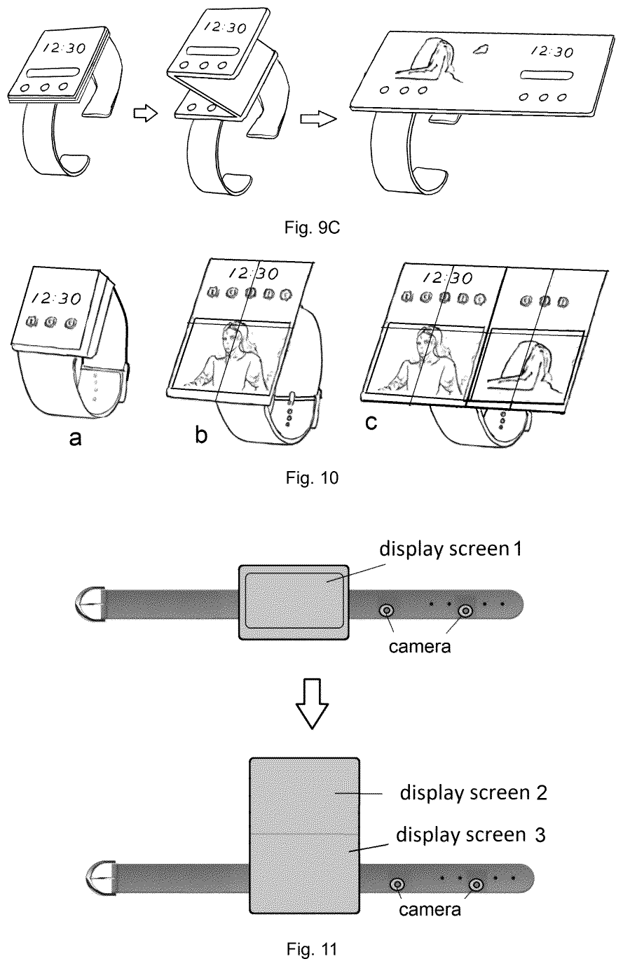

FIGS. 9A, 9B and 9C show other examples of the device having multiple displays. The display can be a foldable display or rollable flexible display such as those disclosed by OPPO Corp, Ltd. In FIG. 9B, the extra displays can be pulled out from the main body. In FIG. 9C, the extra displays are foldable.

In some embodiments, the device can have multiple screen displays. Those disclosed in US patent application No. US20180018930A1 can be used. Examples are shown in FIG. 10. FIG. 10b shows the configuration having 4 displays. FIG. 10c shows the configuration having 8 displays.

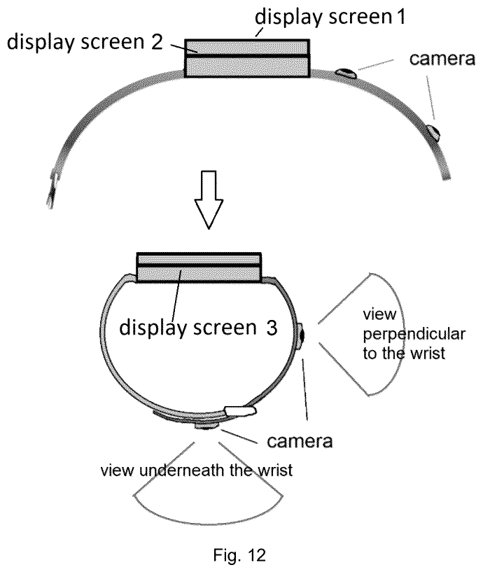

FIG. 11 shows the top view of a smartwatch having a foldable display with 3 display screens and two cameras on its wristband. FIG. 11 top shows the folded configuration having a small display screen 1 visible on top. FIG. 11 bottom shows unfolded configuration having two large size display screens 2 and 3 visible. The cameras are connected to the smart watch main body with wires embedded within the wrist band for power delivery, data transmission and control. One camera can provide the view underneath the wrist of the user and another can provide the side view perpendicular to the wrist once it is worn. FIG. 12 shows a side view of the device of FIG. 11. Display screens 2 and 3 are underneath the display screen 1 when the device is folded. Display screen 1 is on the opposite side of display screen 2.

When multiple cameras are installed in the device, they can be turned on to show their views as small preview image/video on the display or displays at the same time. The user can pick which camera to be used and device will display the image/video the selected camera captures in full on the display/displays and turn off the other cameras or not show their view on the screen. For example, the user can tap the preview on the touch screen to select the camera to be used and content to be displayed.

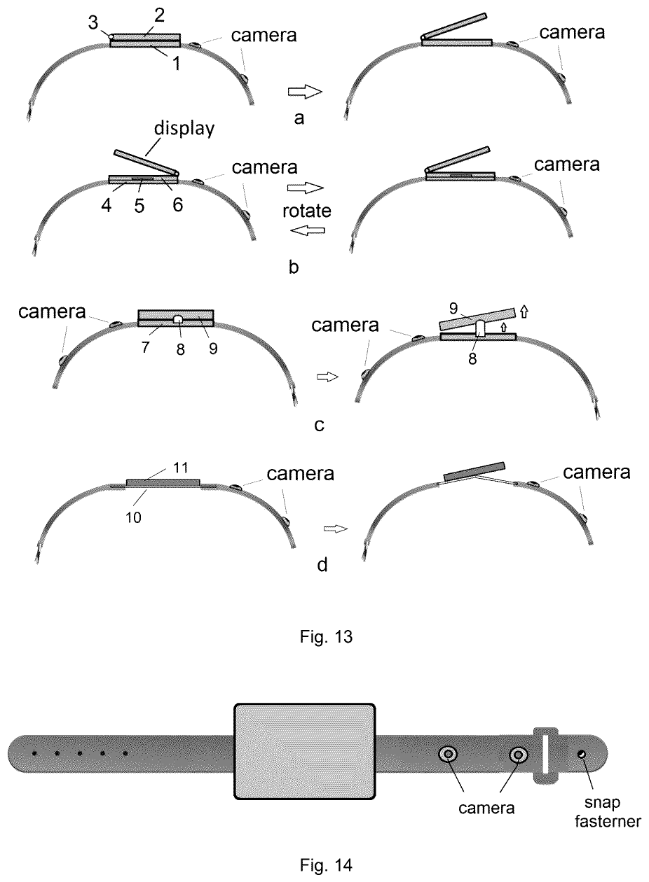

In some embodiments, the display screen can be tilted to provide a better view for the user on the wrist. Means can be incorporated into the device to allow the display to be tilted. Examples are shown in FIG. 13. As shown in FIG. 13a, display 2 is connected to the base plate 1 through a connector 3 such as a rotating shaft or hinge. The display 2 can be lifted up/rotated to desired angle. Another example is shown in FIG. 13b. Two plates 4 and 6 are connected through a rotating shaft 5.

The display is connected to top plate 6 and can be tilted vertically. The display and top plate 6 can also rotate horizontally relative to the bottom base 4 so the display can be tilted to any direction. Another example is shown in FIG. 13c. Base plate 7 has a retractable protuberant structure 8 such as a shaft/pole/beam and display 9 can be titled/rotated on top of 8. Structure 8 can be pulled up/raised to allow display 9 rotate/tilt to the desired degree/direction. FIG. 13d shows another configuration. The base plate 10 can be bent to the desired angle so the display 11 on top of it can also be tilted accordingly.

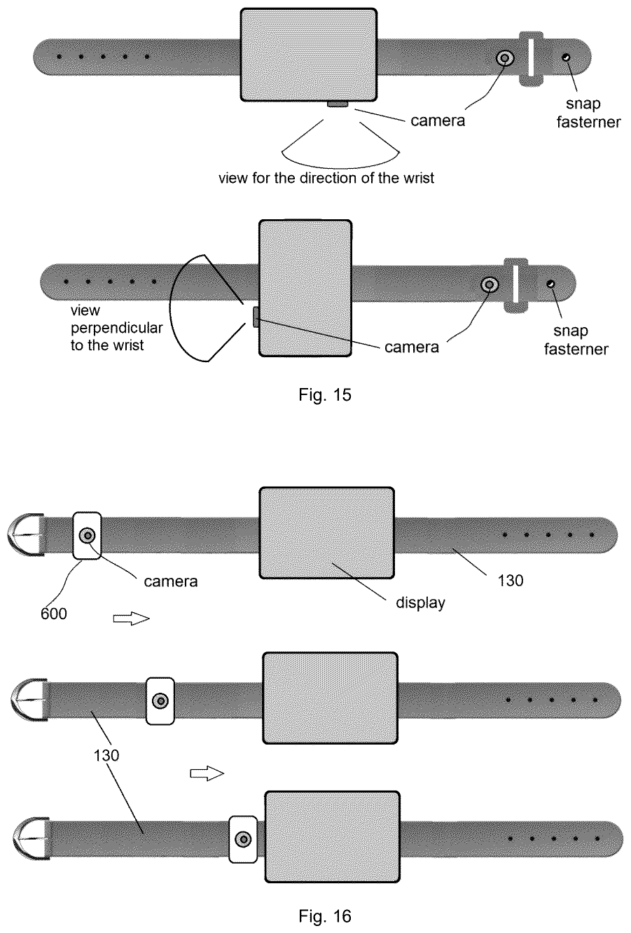

The wristband can be many types of shape, configuration and mechanism same as or similar to existing wristband used for watch, such as elastic closed wristbands (stretchable, closure-free), pin-and-tuck closure type, hook-and-loop closure type, magnetic closure type, and those used for apple watch. FIG. 14 showed an example of the device of the current invention using a wrist band having snap fasteners similar to apple watch 9 sport band. FIG. 14 device has two cameras on the wristband. FIG. 15 top device has one camera on the wristband to provide view underneath the wrist of the user and another camera on the watch main body to provide view for the direction of the wrist. If the main body can be rotated as disclosed before, this camera can also provide a view perpendicular to the wrist as shown in FIG. 15 bottom after the main body is rotated.

In some embodiments, the camera on the wrist can slide to provide a different view. An example is shown in FIG. 16. The camera in a camera housing 600 on the wristband 130 can slide towards the watch main body having a display. FIG. 16 top shows the configuration that allows the camera to provide the view underneath the user's wrist once it is worn. FIG. 16 middle shows the configuration that allows the camera to provide a view perpendicular to the user's wrist once it is worn. FIG. 16 bottom shows the configuration that allows the camera to take a selfie once it is worn.

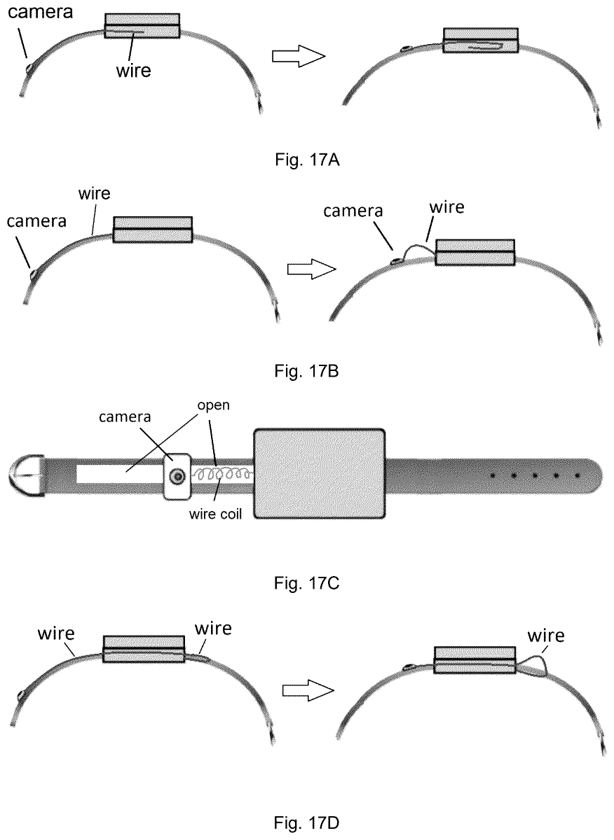

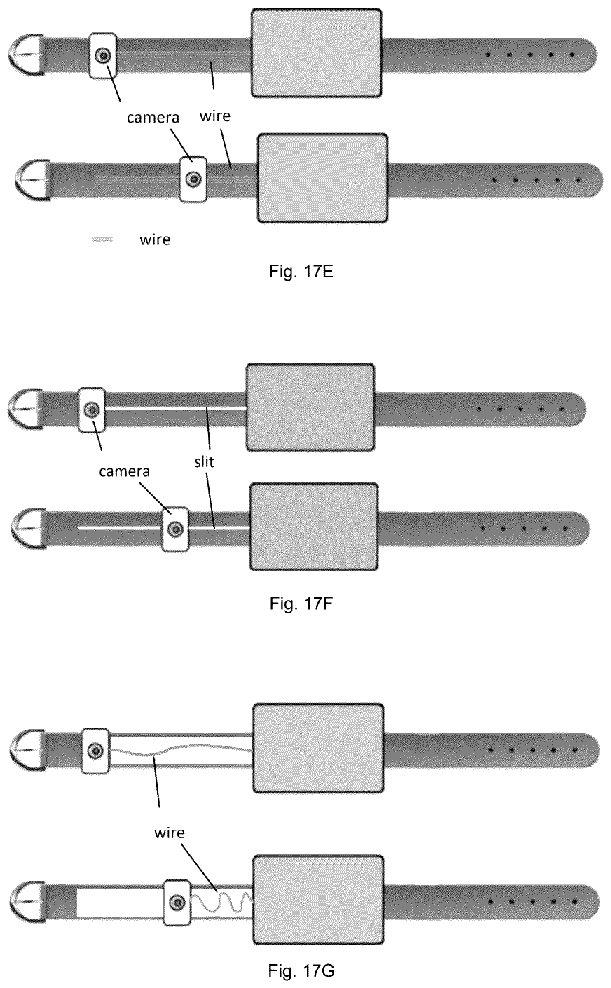

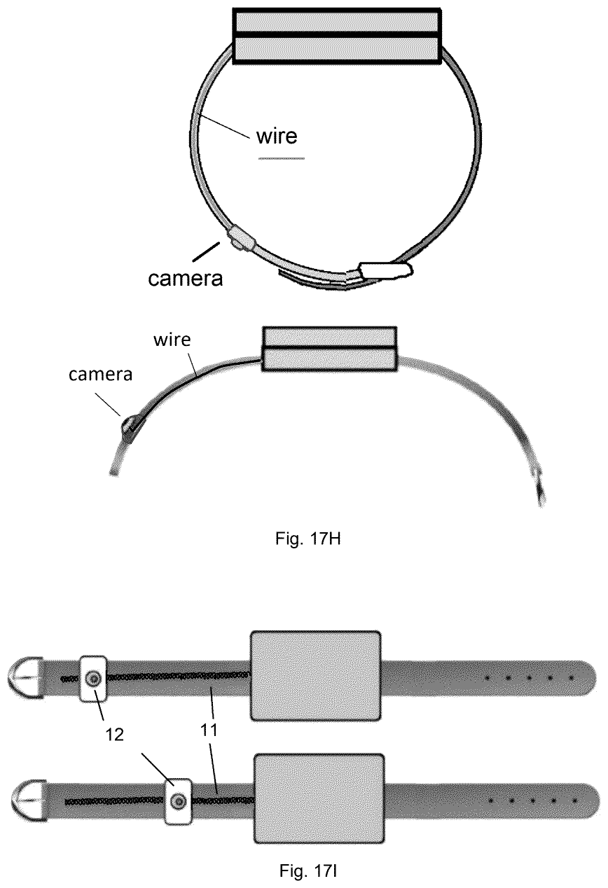

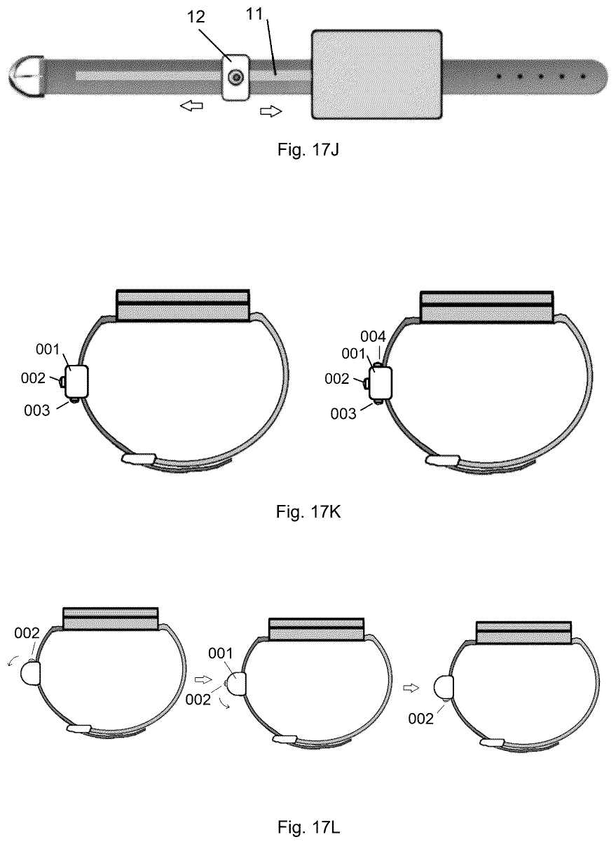

In some embodiments, the power/data wire connecting the camera with the main body is retractable or elastic. It can be placed within the wristband or on the surface of the wristband. An example is shown in FIG. 17A. When the camera slides closer to the main body, the retractable wire bends/winds/rolls up in the main body to save space.

Another example is shown in FIG. 17B. The wire is placed on top of the wristband. When the camera slides closer to the main body, the wire bends and rises up from the wristband, or forms a coil similar to a retractable coil cord.

When retractable coil type wire is used, the wristband can have an opening in the middle to host the wire instead of placing the wire on top of the wristband. Example is shown in FIG. 17C.

Another example is shown in FIG. 17D. The wire runs across the main body and is on the surface of the other end of the wristband. When the camera slides closer to the main body, the wire bends and rises up from another end of the wristband.

In some embodiments, the wire is on the surface of the wristband exposing its electrical conducting surface to form a conducting rail. The wire does not move. The camera slides on the wire/wires to form electrical conducting contact to receive power and provide data transmission. The wire acts like conducting rail. An example is shown in FIG. 17E.

The wire can also be placed inside the cavity of the wristband which has a slit on its surface to allow the camera to be in contact with the wire during sliding. Example top view of the device is shown in FIG. 17F.

In some embodiments, the wire is placed inside the cavity of the wristband. The wristband has a slit so the wire connected with the camera can move freely together with the camera. FIG. 17G shows the transparent view (top cover of the wristband is removed) to expose the wire inside. When the camera slides towards the main body, the wire folds/bends within the wristband to accommodate the movement of the camera. The connection between camera and wire is not changed and no sliding happens between them. FIG. 17H shows the side view of the device of FIG. 17G.

Alternatively, the camera is not connected to the watch main body with wire. Wireless signal is used for data transmission between camera and main body. The camera is powered by its own battery or by wireless power supply provided by the main body/wristband (e.g. similar means used for wireless charging). The data/command exchange between camera and main body is also through wireless communication. An example is shown in FIG. 17I. Camera 12 is powered by wireless power transfer (WPT) and/or wireless energy transmission (WET) using inductive coupling. For example, it receives power from the device main body through the coils of wire 1 embedded in the wrist band. FIG. 17I provides the X-ray view of the coil in the wrist band. Alternatively, the power transfer can be provided by electric fields using capacitive coupling between metal electrodes in the camera and wrist band. The camera can also have a built-in battery/super capacitor to provide power in combination with wireless energy transmission. In some embodiments, a metal magnetic core is embedded in the wrist band instead of the coil. Examples of the material for magnetic core can be ferrite or iron based. In some embodiments, wireless energy transmission is based on resonant inductive coupling or magnetodynamic coupling or electrodynamic wireless power transfer. In some embodiments, the transmitter part (e.g. the coil, magnetic core) is in the device main body instead of the wrist band. In some embodiments, far-field or radiative techniques (also called power beaming) is used for wireless energy transmission.

In some embodiments, the wristband part having camera on it can be longer than the wrist band part without camera, to allow the camera to move to the desired location/angle to be able to face the target object to take picture/video when the device is on the wrist. An example is shown in FIG. 17J. The camera can move freely along the wristband in two directions. Magnetic core 11 is embedded in the wristband to deliver energy to the camera that has a receiving coil inside wirelessly. The coil in the main body of the device is coupled to the magnetic core to provide energy. Alternatively, the magnetic core can be replaced with an induction coil.

In some embodiments, camera housing is on the wristband, which can be either on fixed location or movable along the wrist band, and powered either with wire or wirelessly. More than one camera facing a different direction is integrated within the camera housing. An example is shown in FIG. 17K. Camera housing 001 is on the wrist band. In FIG. 17K left two cameras 002 and 003 are in the housing to provide side view perpendicular to the wristband and downward view respectively. In FIG. 17K right an additional camera 4 can provide an upward view. Alternatively, multiple lenses facing different directions can be used instead of multiple cameras and the lenses can project the image to one image sensor (e.g. CMOS). By selecting which lenses to be in use, the camera housing can selectively provide a view for the target direction.

In some embodiments, the camera or its lens can tilt or rotate to see different directions of view. An example is shown in FIG. 17L. Camera 002 inside the camera housing 001 can rotate clockwise to see views from upward direction, side direction and downward direction accordingly. The rotation can be made manually or controlled by the device main body based on the user's command. The rotating mechanism used in security cameras can be adopted. Alternatively, the lens is rotatable to provide a different direction of view similar to those described above.

In some embodiments, one or more cameras are attached to the main body of the device and the part housing the camera can be rotated for different views. In some embodiments, the part housing the camera can move/slide relative to the main body or be pulled out/ejected or bent or folded or adapt the combination of them. This will give a better and more view for the camera.

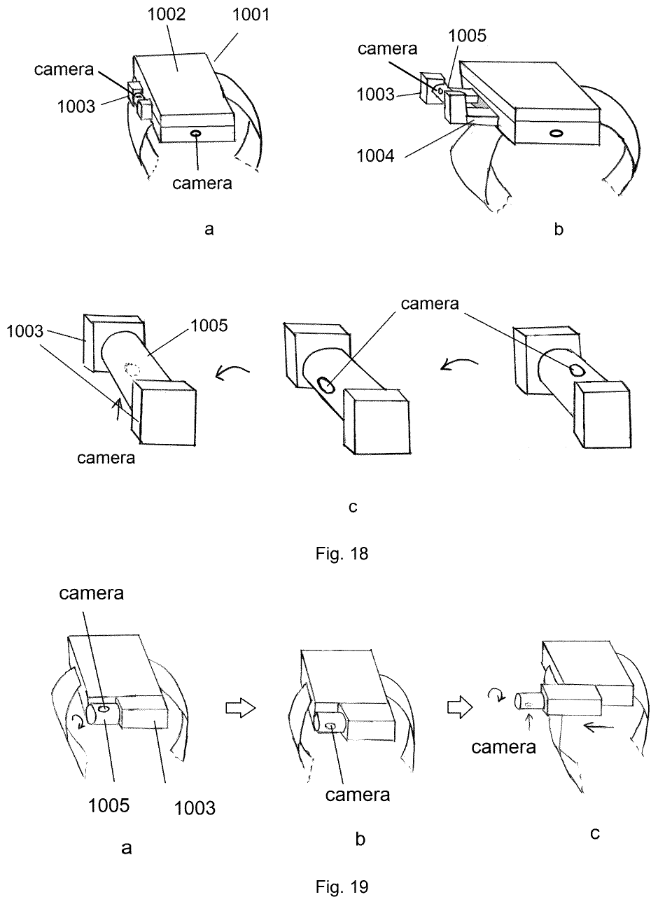

In some embodiments, the camera housing can be rotated and is mounted on a base structure. The base can be pulled out/moved away from the watch main body. Examples are shown in FIG. 18. In FIG. 18a, the device has a main body 1001 having display screen 1002, and base structure 1003 to support a rotatable camera housing. As shown in FIG. 18b, the base 1003 is attached to arm 1004, which can be pulled out from the main body or slid back into the main body. Rotatable camera housing 1005 has a camera embedded in the middle and is attached to base 1003. FIG. 18c shows the camera assembly comprising base and camera housing. In FIG. 18c right, the camera faces upward to allow taking a selfie. When the camera housing 1005 rotates 90 degrees counterclockwise as shown in FIG. 18c middle, the camera can provide a view perpendicular to the user's wrist once the device is worn on the user's wrist. When the camera housing 1005 rotates another 90 degrees counterclockwise as shown in FIG. 18c left, the camera (shown as dotted line) will face downward to provide view underneath the user's wrist. The example in FIG. 18 has two base structures 1003 and two arm structures 1004, less base and/or arm structure (e.g. only 1) can be used in other embodiments. The arm can be replaced with other pull out/ejectable shape/means such as a plate. This mechanism allows the camera to view the object underneath the wrist which would otherwise be blocked by the wrist/wrist band.

In some embodiments, the camera housing can be rotated and is mounted on a sliding base that can slide along the edge of the watch main body. An example is shown in FIG. 19. FIG. 19a shows the camera faces upward to allow taking selfies. When the camera housing 1005 rotates 90 degrees as shown in FIG. 19b, the camera can provide a view to the direction of the user's wrist. When the camera housing 1005 rotates another 90 degrees as shown in FIG. 19c, the camera lens (shown as dotted line) will face downward to provide view underneath the user's wrist. The base 1003 can slide out to avoid the camera view being blocked by the wrist as shown in FIG. 19c when the device is on the user's wrist.

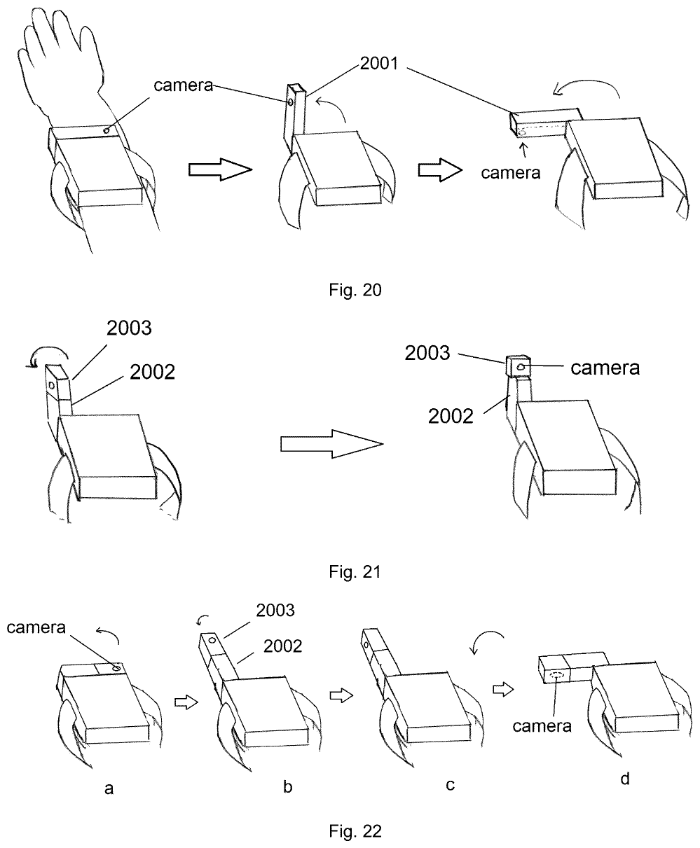

In some embodiments, the camera housing body attached to the side of the main body can be rotated vertically perpendicular to the watch main body planar. An example is shown in FIG. 20. Camera housing body 2001 is attached to the edge of the watch main body with the camera facing upward to allow taking selfies as shown in figure left. When the camera housing body 2001 rotates 90 degrees as shown in the middle figure, the camera can provide a view perpendicular to the wrist. When the camera housing body 2001 rotates another 90 degrees as shown in FIG. 20 right, the camera (shown as dotted line) will face downward to provide view underneath the user's wrist to avoid the camera view being blocked by the wrist. In some embodiments, part of the camera housing body can be further rotated. As shown in FIG. 21, the rotatable camera housing body has two parts: housing body base part 2002 and a housing body top part 2003 which can be further rotated relative to the base part 2002. This will provide additional view for the camera such as the view for the direction of the wrist.

In some embodiments the camera housing body attached to the side of the main body can be rotated in the same planar of the main body and part of the camera housing can be further rotated vertically. Example is shown in FIG. 22. In FIG. 22a the configuration allows the camera to take selfies. The camera housing body comprises the first base part 2002 and second top part 2003. When the camera housing body rotates 90 degrees as shown in FIG. 22b and the top part further rotates 90 degrees as shown in FIG. 22c, the camera will provide a view perpendicular to the user's wrist. Further rotating both 2002 and 2003 as shown in FIG. 22d will provide a view underneath the user's wrist for the camera.

Alternatively, the camera housing body is one piece without a second rotatable top part and it is attached to the main body with a joint that allows multi-planar rotation such as a universal joint. This will provide multi-degree of freedom movement/rotation and allow the same view for the camera as those shown in above figures.

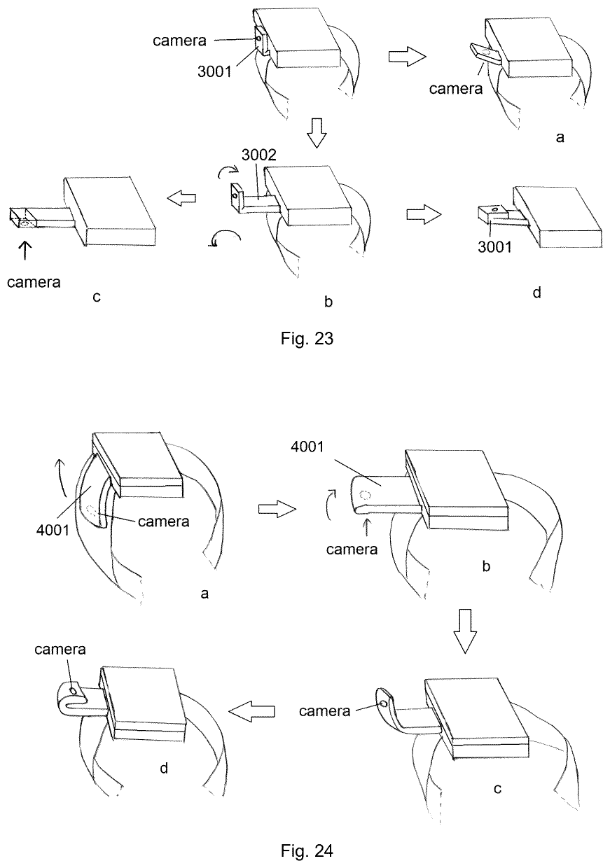

In some embodiments the camera housing body can be folded/bent to provide different view angles. An example is shown in FIG. 23. The camera housing body 3001 can have an optional pull out arm 3002. The camera housing body 3001 can be tilted (e.g. 30-90 degrees as shown in FIG. 23a) to provide a view covering a certain region below the wrist for the camera. The extension pull out arm 3002 can be pulled out to provide more view field for the camera as shown in FIG. 23b,c. The camera containing the end of the housing body can be folded counterclockwise to provide a view underneath the wrist of the user for the camera as shown in FIG. 23c. Or it can be folded clockwise to allow the camera to provide a selfie as shown in FIG. 23d.

In some embodiments the camera housing body connected to the device main body is semi rigid and can be folded/bent into different shapes to provide desired view angle for the camera. An example is shown in FIG. 24. In FIG. 24a the camera housing body is aligned to the surface of the wristband and the camera (shown in dotted line) is facing the wristband. An optional fastening means such as a magnet can be used to attach the camera housing body to the wristband firmly. The camera housing body can be bent clockwise as shown in FIG. 24b to provide view underneath the wrist for the camera. The end having the camera can be further bent as shown in FIG. 24c to allow the camera to provide a view perpendicular to the user's wrist. Bending further to fold it back as shown in FIG. 24d will allow the camera to take a selfie.

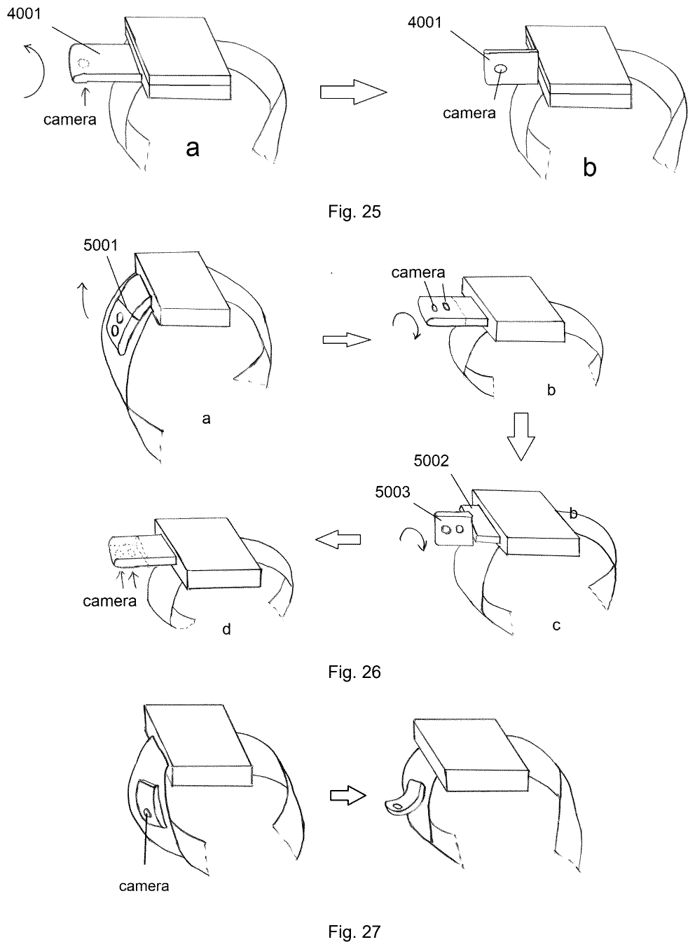

In some embodiments the semi rigid camera housing body can be further rotated to provide additional view for the camera. An example is shown in FIG. 25. The semi rigid camera housing body 4001 is connected to the main body through a rotatable connecting means such as a rotating shaft. When the semi rigid camera housing that provides a view underneath the wrist of the user as shown in FIG. 25a is rotated vertically relative to the housing body as shown in FIG. 25b, the camera will provide a view for the direction of the wrist.

In some embodiments, more than one camera (e.g. 2-4) can be embedded in the camera housing body. One or more additional cameras can be added to the side and/or the surface of the watch type device main body such as those shown in FIG. 18a,b. Additional camera housing body can also be added to the watch type device main body. For example, 2-4 cameras can be placed in each camera housing body of those shown in FIGS. 18-25. An example of two camera configurations is shown in FIG. 26. The camera housing body 5001 of the device in FIG. 26 further has a rotatable part 5003 and a base part 5002 connected with device main body. The configuration in FIG. 26a allows the camera to provide a view perpendicular to the user's wrist. The configuration in FIG. 26b allows the camera to take selfies. By rotating part 5003 90 degrees as shown in FIG. 26c, it allows the camera to provide a view for the direction of the wrist. By rotating part 5003 another 90 degrees as shown in FIG. 26d, it allows the camera to provide a view underneath the user's wrist.

In some embodiments, the camera housing body is immobilized on the wrist band instead of directly attached to the main body. Example is shown in FIG. 27. The camera housing body can be bent/folded to provide a different view for the camera. It can further be rotated to provide additional view fields.

In some embodiments, the device is a head wearable (head worn, head mounted) type smart device, which comprises one or more camera, one or more microphone and speaker, means (hardware and software) to communicate with a host device such as a mobile device (e.g. a smart cell phone) or computer or cloud computing source, and can transmit data including command, image/video/sound between said wearable device and host device. In some embodiments, the device further comprises one or more displays.

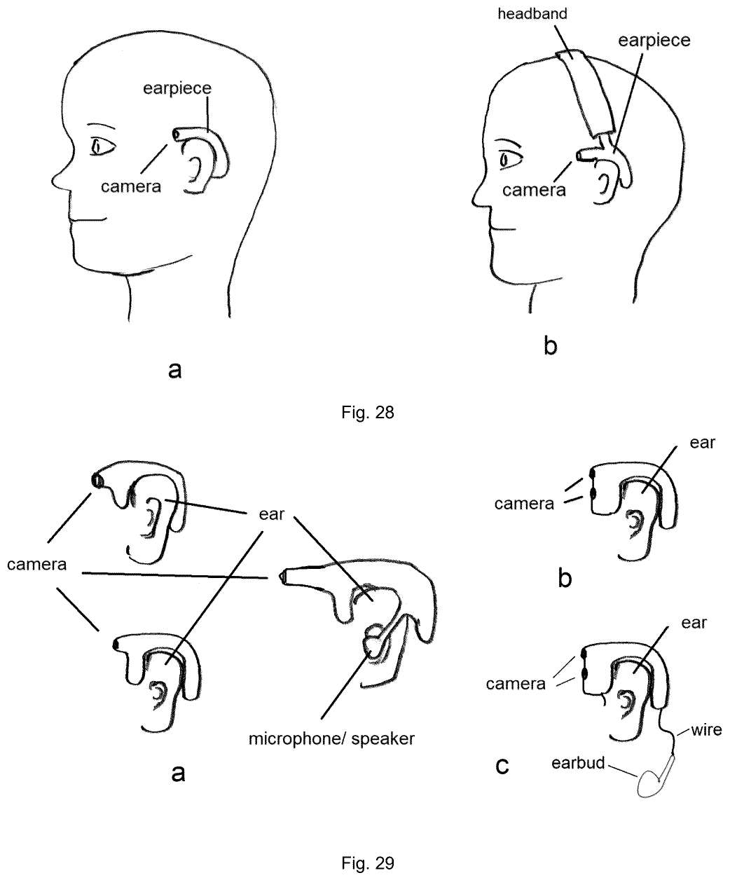

In some embodiments, the device is an earpiece that can be placed (e.g. hung) on the ear. The earpiece can have a hook type shape so it will stay on top of the ear. The camera is placed at the front end of the earpiece and the lens aims at/points to the forward direction to allow the camera to have the same view direction as the user's eye when the user looks forward. The earpiece contains a built-in power source (e.g. battery) and electronic components required for its function. The earpiece can have one or more control buttons or touch/tap control on it to control it such as on/off control and function control. An example is shown in FIG. 28a. In some embodiments, the device further comprises a headband. The headband can bear the weight of the device to reduce the pressure to the ear. Electronics components such as battery and some electronic circuitry can be placed within the headband. An example is shown in FIG. 28b.

The earpiece can have many different shapes/configurations. Examples are shown in FIG. 29. Other shapes/configurations can also be adopted such as those similar to headset phones and bone conduction headphones. The earpiece can have more than one camera. An example of having two cameras is shown in FIG. 29b,c. In some embodiments the earpiece further comprises a speaker or both speaker and microphone. Examples are shown FIG. 29a,c. The speaker/microphone can be connected to the earpiece main body with a rigid/semi-rigid arm or wire, or is part of the main body. In FIG. 29c, the speaker and microphone is a ear bud connected to the earpiece with wire.

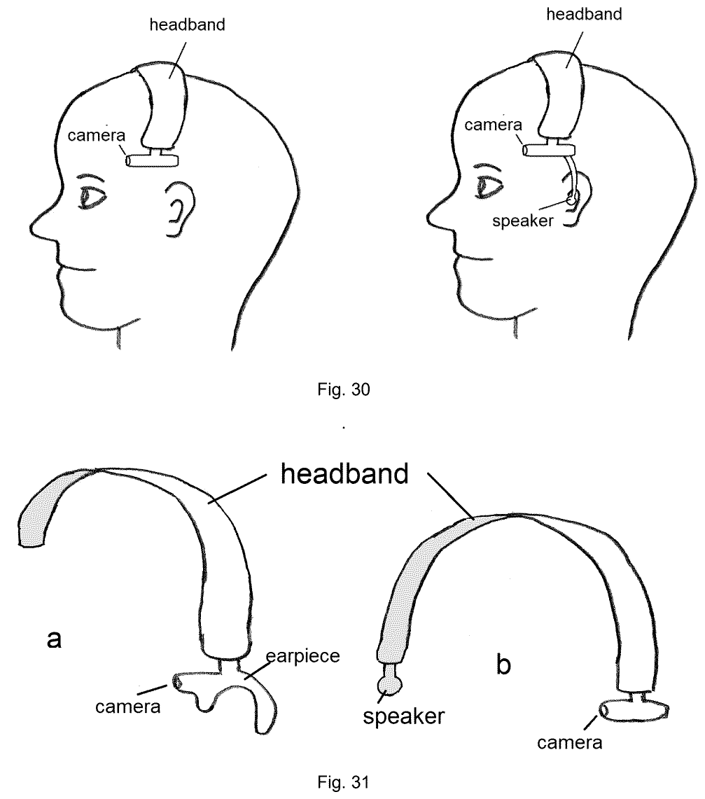

When headband is included in the head wearable device, the device comprising camera and optional speaker/microphone can be not in direct contact with the ear. The housing body of the device containing a camera is hung close to the side of the face such as the temple area or the area above the ear or the area close to the zygomatic bone. However the device is essentially the same as said earpiece except it does not need to have a shape to be hung directly on the ear. For illustration purposes, it is still called earpiece throughout the current application. The device main body is defined as the housing having a camera and does not include the headband. The main body hosts the forward aiming camera and optional speaker/microphone is attached to or within the main body. Examples are shown in FIG. 30.

In some embodiments, the camera aiming direction can be adjusted to another direction so it will be able to cover more than the front view. e.g. by bending/rotating the part containing the camera.

When a headband is used, the head wearable device can be single sided or dual sided. Single sided means the camera and optional speaker/microphone is only on one side of the head band, which configuration is similar to existing single-sided one ear headphone. An example is shown in FIG. 31a. The configuration of the head band can be unsymmetric (e.g. the length of one side is shorter). In some embodiments, the battery can be placed on the shorter side which can balance the weight.

Dual sided means both sides of the headband are attached with camera or speaker/microphone or other electronic components. For example, both sides can have a camera and/or speaker/microphone; or one side has a camera another side has speaker/microphone. An example is shown in FIG. 31b.

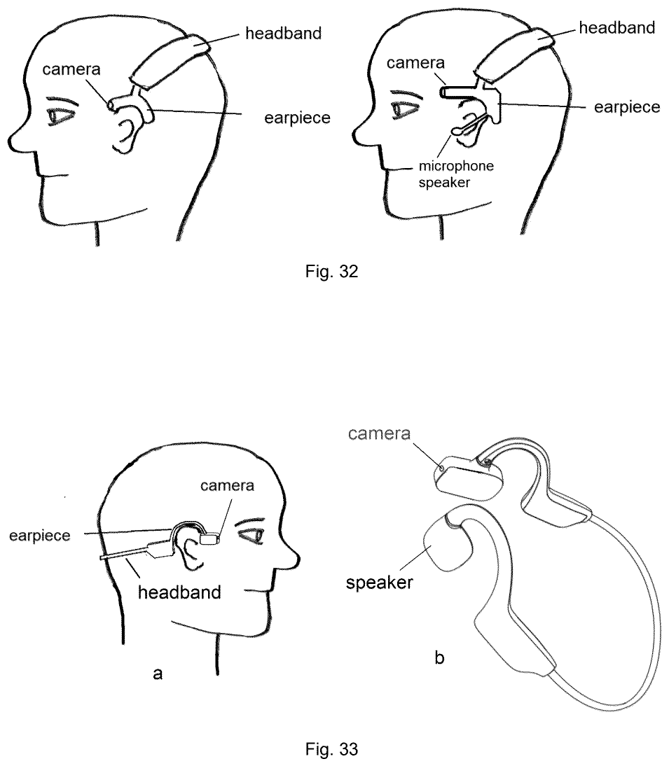

The headband can be vertical as shown before. It can also lean forward or backward. An example is shown in FIG. 32.

The headband can also be horizontal or close to horizontal. The head band orientation can be similar to that used in bone conduction headphones. An example is shown in FIG. 33. The speaker can be a bone conduction speaker as well.

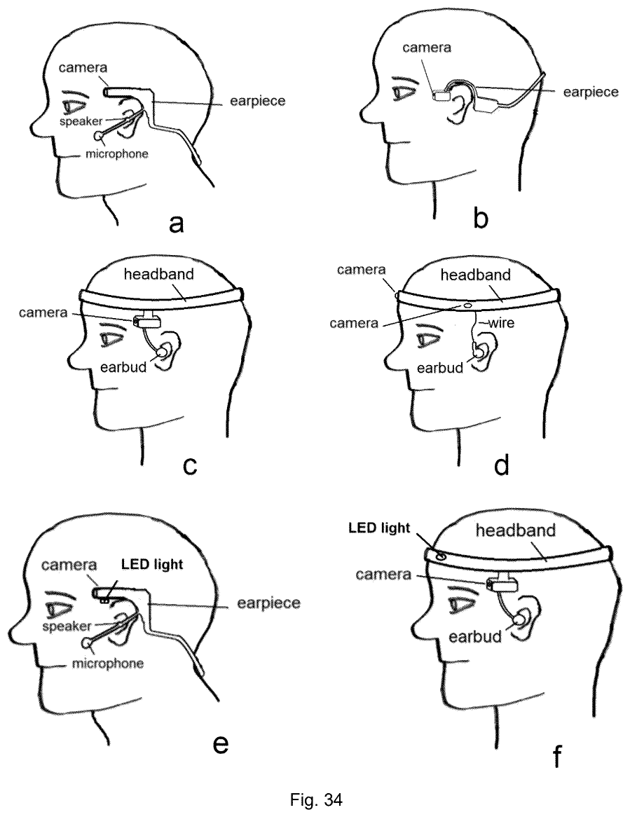

The headband can also be in a curved configuration to allow the head band to be able to at least partially support the weight of the device. Examples are shown in FIG. 34a,b. In FIG. 34a, the weight of the device can be supported by the neck through the headband. In FIG. 34b, the weight of the device can be supported by the back of the head through the headband. FIG. 34c shows another type of headband configuration which is placed horizontally around the forehead. The camera is attached to the headband and earbud is attached to the camera housing or directly to the head band. In FIG. 34C the camera housing is hung below the headband, alternatively the camera housing can also be directly placed on the surface of the headband or the camera is integrated with the headband. When the camera is integrated with the head band, it can be either on the forehead region of the headband or side face region of the headband or both. An example is shown in FIG. 34d. Additional cameras can also be incorporated for more view as shown in FIG. 34d.

In some embodiments, the head wearable device has one or more camera and video indicator light such as an LED. The video indicator LED will turn on/blink when the camera is on to inform the people In front of the camera that he is being videoed. Examples are shown in FIGS. 34e and f, LED video indicator light is placed beneath the earpiece in FIG. 34e, and is placed on the headband in FIG. 34f. When users are taking photos or videos, a breathing light will light up to remind the person on the other side that you are filming. In some embodiments, there are two ways to activate camera: the first is to use voice activation, first use certain word to activate the voice assistant, and then issue commands such as “Take a Picture”, “Take a Video”, “Start/Stop Recording”, etc.; the second is to use a button on the device, such as a single click to take a photo, long press to take a video, and click again to stop recording. Users can also use the wrist wearable device or cell phone to activate the camera.

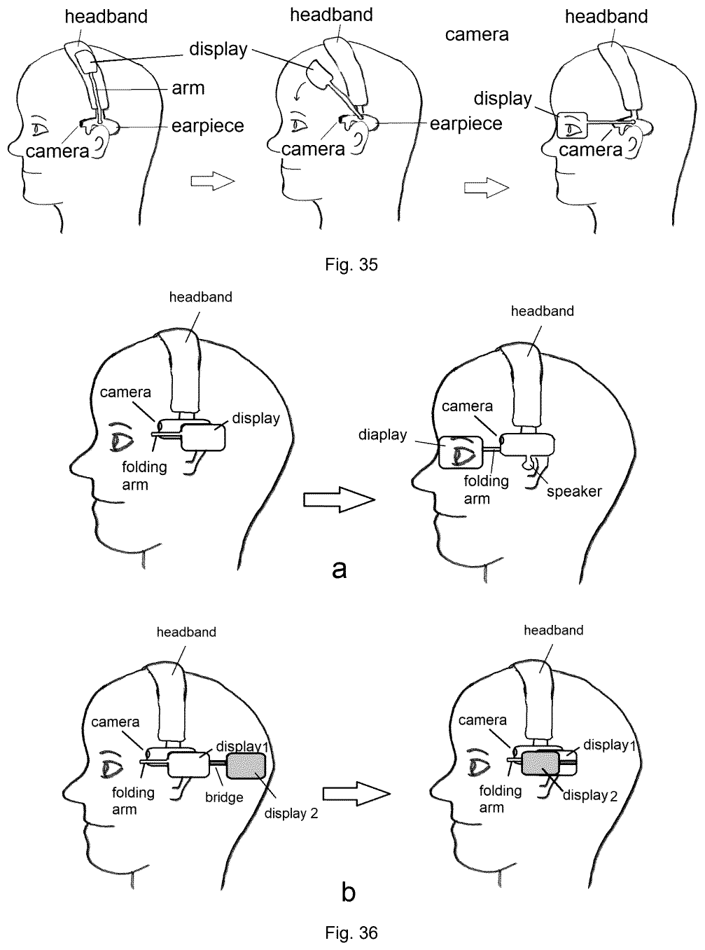

In some embodiments, the device further comprises one or more displays. The display can be a glasses such as a HUD display. The display can be foldable or can be moved to or moved away from the user's eye area so the user can use it only when it is needed. An example is shown in FIG. 35. The HUD display is attached to the earpiece through a rotatable arm. When not in use, it is placed on top of the head band. When the user needs to see the display, it is pulled down to be in front of the user's eye to display the content. An example using a display with a foldable arm is shown in FIG. 36a. FIGS. 35 and 36a show one HUD covering the left eye. The device can also have another HUD covering the right eye as well which is coupled to the right end of the headband so two displays are in the system. The user can use either of them or both of them simultaneously.

Head-up display, also known as a HUD, is any transparent display that presents data without requiring users to look away from their usual viewpoints. However, in current inventions, when one display is used to only cover one eye, the display can be not transparent; for illustration purposes, it is still called HUD. HUD includes head-mounted display (HMD) such as optical head-mounted display (OHMD). Various techniques have existed for see-through HMDs, such as “Curved Mirror” (or Curved Combiner) based and “Waveguide” or “Light-guide” based.

The HUD can have 2 displays (one for each eye). The HUD having two lenses/displays can have a nose piece (e.g. nose pads, similar to those in the glasses) and a bridge between the two lenses/displays, which makes the HUD essentially a glasses. Smart glasses are also a type of HUD/HMD. Alternatively, a one piece long display is used and it is big enough to cover both eyes. FIG. 36b shows an example of a HUD having two displays (one is labeled with grey color for illustration purpose) connected with a foldable bridge. The second display can fold back to the front to save space. The folding/rotating mechanism of the HUD can also be similar to those in FIG. 35, so that the HUD can be rotated to be on top of the head.

In some embodiments, the camera can be on the HUD or the arm of the HUD instead of the earpiece shown in the figures above, which is similar to those in existing smart glasses. In other embodiments, the HUD is in the shape of glasses and the camera is installed on the HUD (such as at the front of the glass frame) similar to the camera configuration used by the existing smart glasses.

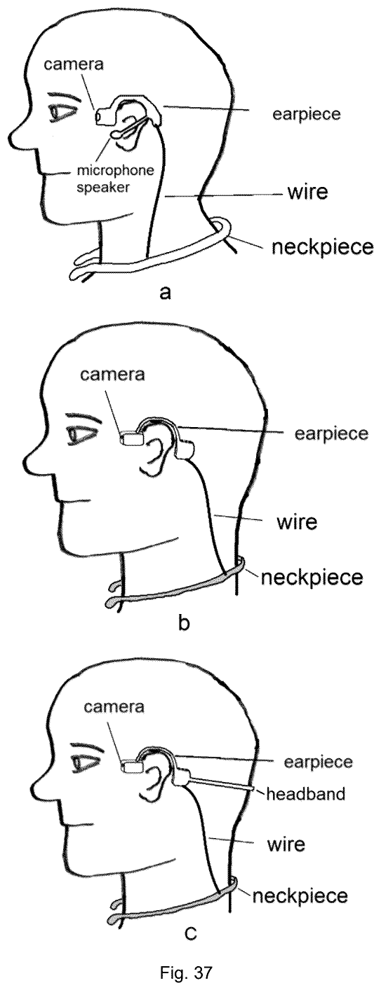

In some embodiments, instead of using a headband, a neck piece is used. Electronics components such as battery and some electronic circuitry can be placed within the neck piece. The neck piece can be in the shape of a necklace or neck ring or neckband similar to those used in neckband headphones. The neckpiece can share the weight of the device which can reduce the pressure to the ear. Examples are shown in FIG. 37. The device can further comprise an optional head band similar to those shown before.

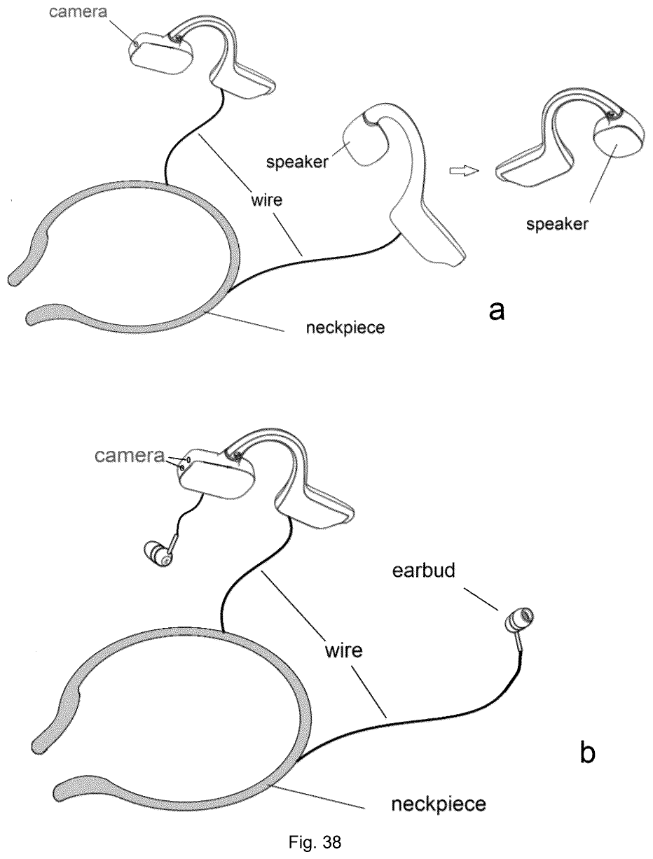

FIG. 38 shows examples of the device with a neckpiece not on the user's head. Example in FIG. 38a has an earpiece with camera and an optional earpiece with bone conduction headphones. Example in FIG. 38b has an earpiece with camera/earbud and an additional earbud. The control button/tap control can be located in either the earpiece or the neck piece.

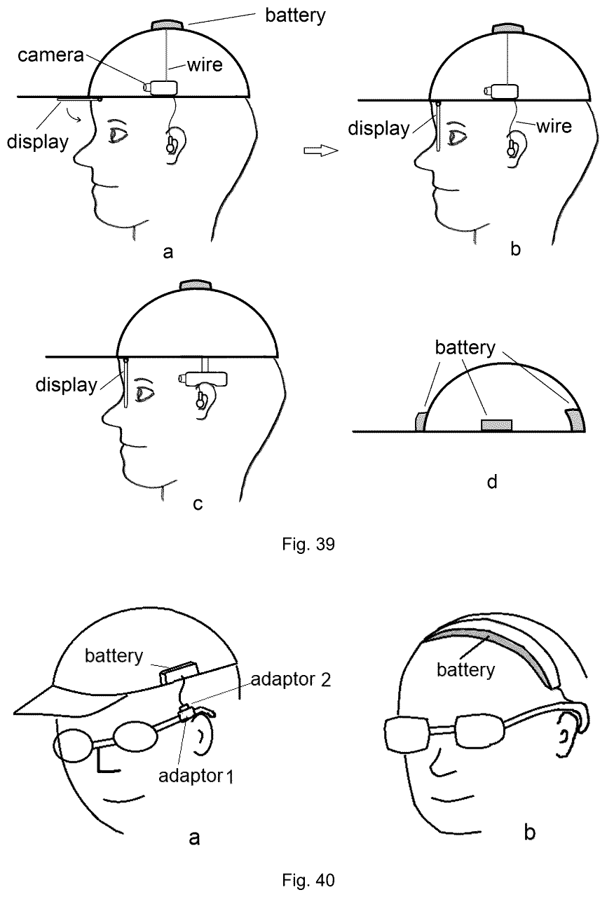

In some embodiments, the head wearable device has a shape/configuration of a hat. The battery pack is placed on the hat (e.g. placed on top of the hat or side of the hat). The camera is on the front or the side of the hat. Examples are shown in FIGS. 39a and 39b, or within the display module attached to the hat. The camera can also be on the earpieces similar to previously described attached to the hat as shown in FIG. 39c. The display can be a HUD as previously described or glasses. The display can be foldable or rotatable so that it can be placed in front of eyes when in use and not in front of the eyes when not in use. As shown in FIGS. 39a and 39b. HUD display is folded back to the hat when not in use and pulled down to be in front of the eyes when being in use. Microphone and speaker can be attached to the hat when not in use and pulled down to be in the ear when being in use. Wired or wireless microphone/speaker can be stored on the side of the hat (e.g. with magnetic attachment) or in a pocket of the hat and attached to the ear/face when they are in use. Battery can be placed on top of the hat or at the front side or the rear part of the hat. When the battery is placed in the mid region of the hat, the device can be placed on the other side of the hat to balance the weight. Examples are shown in FIG. 39d.

Modern mobile devices (e.g., smart phones, tablet computers) often include an embedded camera and microphone that allows a user to take digital images or videos or sound of spontaneous events for recording or other applications such as AI based image recognition. However the user has to pull out the cellphone and hand hold it for the events which is not always convenient.

The wearable devices of the current invention (wearable watch device and head wearable device) are wearable multimedia devices. Systems, methods and devices are disclosed for the wearable multimedia device and host computing platform with an application ecosystem for processing multimedia data captured by the wearable multimedia device. The wearable device can take picture/video and/or receive audio signal (multimedia data) using its embedded camera/microphone, and transfer the captured visual/audio data to the host device (e.g. a paired cell phone with AI applications embedded) using wireless communication (e.g. Wi-Fi, NearLink), the host device process the received data with the embedded application and transfer command/resulting data (if they are generated) back to the wearable device, the wearable device receives the command/resulting data and acts accordingly such as display their content on its screen to the user and/or produce sound (e.g. speech) with its speaker for the user. Using a wearable device is much more convenient than using a cellphone and offers hand free operation. It can be used for performing actions and assisting with tasks like web searches, image recognition, streaming music, dialogue and information exchange, language translation, find places, online shopping, ordering delivery, transportation services, etc.

In an embodiment, the method comprises: receiving, by the paired host device, context data from a wearable multimedia device, the wearable multimedia device including at least one data capture device for capturing the context data; creating, by the host device, a data processing pipeline with one or more applications based on one or more characteristics of the context data and a user request; processing, by the host device, the context data through the data processing pipeline; and sending, by the host device, output of the data processing pipeline to the wearable multimedia device or other device for presentation of the output.

In an embodiment, the wearable device comprises a camera, a display and/or a speaker to perform operations comprising: capturing, using the camera, a set of digital images; transferring the images to a host device to identify an object in the set of digital images and obtain data associated with the object; and sending data back to the wearable device, displaying the data in the display or speaking out the data content in audio using the speaker.

In an embodiment, the wearable device comprises a camera, a microphone, a display and/or a speaker to perform operations comprising: capturing, using the camera and/or the microphone, a set of digital images and/or audio signal; transferring the images/audio signal to a host device (e.g. a cell phone) to identify an object in the set of digital images/audio signal and obtain data associated with the object; and sending data back to the wearable device, displaying the data in the display or speaking out the data content in audio using the speaker.

For example, if the user wants to obtain related information for a subject (e.g. a plant) he sees, he can point the camera of the wearable device to the device and give voice command to the device's microphone to search related information, the captured image is sent from the wearable device to the user's cellphone which is paired with the wearable device, the cellphone will use its image recognition app to identify the object and search online for the related information, and then send back the related information to the wearable device. The speaker of the wearable device can provide the data in audio format to the user, or the display of the wearable device can show the user the data in text or image/video form, or combination of them. If the wearable device has a touch screen, it can also be used to control the wearable device and interact with the host device interactively. The cellphone can further use a cloud computing service to handle the task. When taking an image/video, the display of the wearable device can show the image the camera is capturing in real time so the user can capture/monitor the image of interest accurately.

In another example, the user is reading a question and needs to find the answer. He can use the camera of the wearable device to capture the question and speak to the wearable device giving a command to find the answer. The wearable device passes the question and command to his cellphone, the cell phone consults with ChatGPT or google Gemini and sends back the answer to the wearable device without any direct operation to the cellphone by the user, the wearable device presents the answer to the user in its display or speaker or both.

In some embodiments when the task can be handled by the App residing in the wearable device, e.g. language translation, it does not need to pass the data to the host device and all the work can be done by the wearable device by itself. In this scenario the wearable device can work independently without communicating with the host device (offline mode).

If the wearable device has direct internet access (e.g. can use the cellphone network), the wearable device can communicate and work directly with a cloud computing service, wherein the host device is the cloud computing service. This format is similar to those in other AI peripheral devices such as the AI pin from Humane Inc and Rabbit R1.

In some embodiments, the wrist wearable device can communicate with an earphone directly or indirectly though host device (e.g. wrist wearable device communicates with host device and the host device communicates with the earphone accordingly; or wearable device communicates with ear phone directly so that the ear phone will speak out based on the command/text sent by the wearable device).

In some embodiments, the data output device (e.g., text, sound, image/video) can be a cellphone such as the host device in the system instead of a wearable device.

In some embodiments, the wrist wearable device, head wearable device and host device work together and form a network so that one wearable device works as a data collecting device and another works as a data display device. And one wearable device can control another wearable device directly or indirectly through the host device. For example, the head wearable device can transmit data including image/video/sound captured by its camera and microphone to the host device, the host process the data and send back data/command to the wrist wearable device wirelessly, the wrist wearable device can follow the command from the host device and present the data from the host device to the user in the display of the wrist wearable device. Alternatively, the wrist wearable device can transmit data including image/video/sound captured by its camera and microphone to the host device, the host device process the data and send back data/command to the head wearable device wirelessly, the head wearable device can follow the command from the host device and present the data from the host to the user in the display of the head wearable device and its speaker. In another example, the head device receives command from the user and sends the command directly to the wrist device, or sends the command to the host device and then the host device sends the command to the wrist device. In another example, the wrist device receives command from the user and sends the command directly to the head device, or sends the command to the host device and then the host device sends the command to the head device.

In some embodiments, the head wearable device is a glasses or includes a glasses, wherein the glasses has a display, which can be similar to those in existing smart glasses except the head wearable device needs to communicate with the host computer (e.g. a cell phone) to process the data it collects. The glasses can have one or more cameras and displays on it. For example, superimposing information onto a field of view can be achieved through an optical head-mounted display (OHMD) or embedded wireless glasses with transparent heads-up display (HUD) or augmented reality (AR) overlay. In some embodiments, the configuration of the glasses can be similar to current smart glasses except the AI based application and the hardware for AI computing is not embedded within the glasses of the current invention. The glasses type head wearable device of the current invention further includes communicating means to send data to host computer (e.g. a cell phone) and receive command/result generated from the host computer. And then it displays the result content to the user. Because the AI based computing is performed by the host computer, the glasses of the current invention does not need to have the sophisticated hardware/computing power required for it. The glasses of the current invention can be seen as a simplified version of existing smart glasses with additional communication means with host computer. The system of the current invention using said glasses further comprises a host computer and a headband or neckpiece hosting a battery.

In some embodiments, a dedicated App is in the host device and wearable device to perform the tasks, such as communicating between the host device and the wearable device, controlling the wearable device and host device, coordinating the jobs between the wearable device and the host device, executing the tasks assigned by the user.

In some embodiments, the headband can be on top of the head or on the back of the head. The headband can tilt, rotate and its distance/direction to the earpiece can be adjusted, and the related mechanical means (e.g. a rotating shaft or other rotatable mechanism) is incorporated with the device.

In some embodiments of the head wearable devices of the current inventions, the camera direction can be tilted adjusted/rotatable and the related means (e.g. a rotating mechanism or semi rigid bendable structure) is incorporated within the device.

The current invention also disclose a system comprising a wearable battery and a head wearable device (e.g. the head wearable devices disclosed of the current invention or smart glass or the like. The wearable battery can charge the head wearable device and/or provide power to the head wearable device.

The current invention also discloses a system comprising a wearable battery (such as a wrist wearable battery) and a wrist wearable device such as the wrist wearable device of the current disclosure or smart watch. The wearable battery can charge the wrist wearable device and/or provide power to the wrist wearable device.

The current invention also discloses a wearable battery, which can be worn on the head or worn on the wrist or hung on the neck or placed on the shoulder. The wearable battery charges a wearable device (such as a head wearable device or a wrist wearable device) and/or provides power to the wearable device to form a system as disclosed above.

The wearable battery comprises one or more battery packs (such as one or more rechargeable battery packs) and means to attach/affix/couple the battery pack to the human body part such as head, neck and wrist. Said means include hat, neckpiece structure, wrist band, and etc. The battery pack is installed on/in a hat or headband or necklace or wrist band.

In some embodiments, the wearable battery is placed on a hat and it can power the head wearable device. An example is shown in FIG. 40a, the battery is placed on the side of the hat and it can power a head wearable device such as a smart glasses. The hat can have one or more pockets to host the battery. To power the smart glasses including commercially available smart glasses, a 1^{st} charging adaptor can be added to existing smart glasses, and the wearable battery can have 2^{nd} charging adaptor at the end of it power output wire to attach to the 1^{st} charging adaptor magnetically (e.g. similar to the Surface Connect charging interface of Microsoft surface laptop). In the FIG. 40a, adaptor 1 is the 1^{st} charging adaptor, adaptor 2 is the 2^{nd} charging adaptor.

In some embodiments, the wearable battery is placed on a headband and it can power the head wearable device. An example is shown in FIG. 40b, the battery is placed inside the head band and it can power a head wearable device such as a smart glasses.

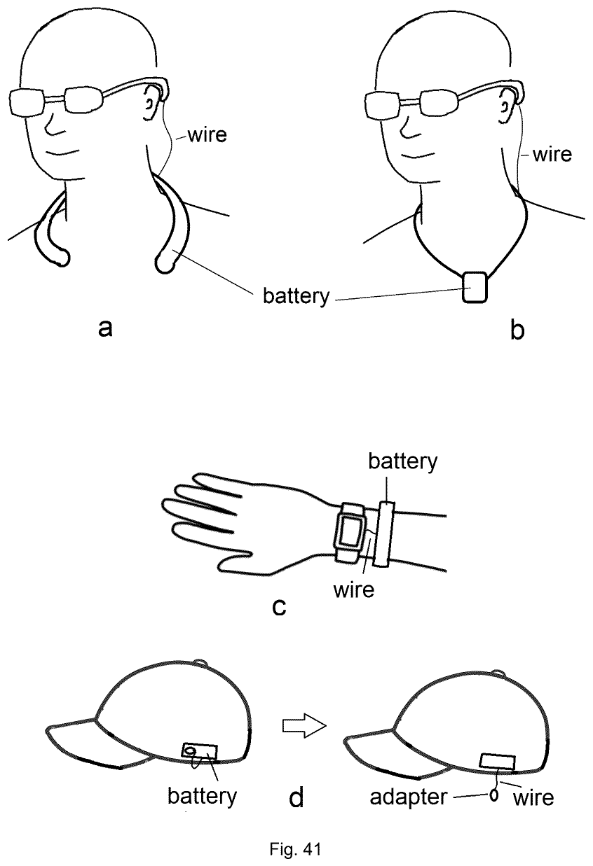

In some embodiments, the wearable battery is in the form of a neck piece (such as necklace, neck ring and necklace pendant) and it can power the head wearable device. Examples are shown in FIG. 41a,b, the battery is placed inside the neck piece and it can power a head wearable device such as a smart glasses or the head wearable device of the current invention.

In some embodiments, the wearable battery is placed on a wristband that can power the wrist wearable device. An example is shown in FIG. 41c, the battery is placed on the wrist band and it can power a wrist wearable device such as a smart watch. FIG. 41d shows an example of a wearable battery in the form of a hat. Battery pack is placed in the side pocket of the hat. The wire to charge other devices can be attached to the hat with a magnet when not in use and be pulled down to charge the device when in use.

In some embodiments, the housing for the wearable battery can further include other electronic components such as communicating module, computing module/data processing module that can process the data (e.g. image/video/sound) generate by the wearable device and execute commands, and communicate between the wearable device and the optional host device. So that some of the function can be performed by the wearable battery housing instead of integrated within the wearable device (e.g. smart glasses), which will make the wearable device such as smart glasses have lighter weight and less hardware required within the wearable device.

In summary, the current invention discloses a system for AI applications, comprising a host device such as a cell phone and a wrist wearable device that can capture multimedia data including digital image, video and sound based on a user's command. The host device such as a smart cellphone communicates with the wearable device and processes the multimedia data captured by the wearable device; wherein the wearable device has one or more camera, microphone, display, speaker and a wristband. The wearable device comprises communication means that sends the multimedia data to the cell phone with wireless signal, the smart cellphone processes the multimedia data with its embedded AI application and transfers the result including command back to the wearable device, the wearable device receives the result and acts accordingly to inform the user the result visually on its display or audio output. In some embodiments, said display of the wearable device is foldable. In some embodiments, said camera can slide on the wristband. In some embodiments, said camera can be rotated.

The current invention also discloses a system for AI applications, comprising a host device such as a cell phone and a head wearable device that can capture multimedia data including digital image, video and sound based on a user's command. The host device such as a smart cellphone communicates with the wearable device and processes the multimedia data captured by the wearable device; wherein the wearable device has one or more camera, microphone, display, speaker and a headband. The wearable device comprises communication means that sends the multimedia data to the cell phone with wireless signal, the smart cellphone processes the multimedia data with its embedded AI application and transfers the result including command back to the wearable device, the wearable device receives the result and acts accordingly to inform the user the result visually on its display or audio output. In some embodiments, said display of the wearable device can be rotated. In some embodiments, said headband contains battery. In some embodiments, said camera is placed on top of the user's ear.

In current disclosure, the term “wearable device” and the term “worn device” are interchangeable. For example, a head wearable device and a head worn device have the same meaning. Head wearable devices can also be called head-mounted devices.

In the current application, the “/” mark means “and” and/or “or” and/or their combination. Unless otherwise defined, all technical and scientific terms used herein have the same meaning as commonly understood by one of ordinary skills in the art to which this invention belongs. All patents and publications mentioned in this specification are indicative of the level of those skilled in the art to which the invention pertains. All patents and publications are herein incorporated by reference to the same extent as if each individual publication was specifically and individually indicated to be incorporated by reference. The inventions described above involve many well-known knowledge, instruments, methods and skills. A skilled person can easily find the knowledge from textbooks, scientific journal papers and other well-known reference sources.

1. A system for AI applications, comprising
a wrist wearable device that can capture multimedia data including digital image, video and sound based on a user's command;
a smart cellphone that can communicate with the wearable device and process the multimedia data captured by the wearable device;
wherein the wearable device has one or more camera, microphone, display, speaker and a wristband;
wherein the wearable device sends the multimedia data to the cell phone with wireless signal, the smart cellphone processes the multimedia data with its embedded AI application and transfers the result including command back to the wearable device, the wearable device receives the result and acts accordingly to inform the user the result visually on its display or audio output.

2. The system of claim 1, wherein said display of the wearable device is foldable.

3. The system of claim 1, wherein said camera can slide on the wristband.

4. The system of claim 1, wherein said camera can be rotated.

5. The system of claim 1, wherein more than one said cameras are on the wristband.

6. A system for AI applications, comprising
a head wearable device that can capture multimedia data including digital image, video and sound based on a user's command;
a smart cellphone that can communicate with the wearable device and process the multimedia data captured by the wearable device;
wherein the wearable device has one or more camera, microphone, display, speaker and a headband;
wherein the wearable device sends the multimedia data to the cell phone with wireless signal, the smart cellphone processes the multimedia data with its embedded AI application and transfers the result including command back to the wearable device, the wearable device receives the result and acts accordingly to inform the user the result visually on its display or audio output.

7. The system of claim 6, wherein said display can be rotated.

8. The system of claim 6, wherein said headband contains battery.

9. The system of claim 6, wherein said camera is placed on top of the user's ear.
